(19) United States
(12) Patent Application Publication
(10) Pub. No.: US 2005/0034475 A1
(43) Pub. Date: Feb. 17, 2005

(54) Venting arrangement for a vehicle refrigerator and related method

(76) Inventor: J. H. Van Leeuwen, Zundert (NL)

Correspondence Address: HARNESS, DICKEY & PIERCE, P.L.C., P.O. BOX 828, BLOOMFIELD HILLS, MI, 48303, US

(21) Appl. No.: 10/805,510

(22) Filed: Mar. 19, 2004

Related U.S. Application Data
(60) Provisional application No. 60/456,703, filed on Mar. 21, 2003.

(51) Int. Cl. B60H 1/32; F25B 27/00; F25D 17/04; F25B 39/04

(52) U.S. Cl. 62/404; 62/243; 62/323.1; 62/506

(57) ABSTRACT

A venting arrangement for a vehicle refrigerator including a lower vent assembly and an upper vent assembly. The lower vent assembly provides ventilation intake for cooling of refrigeration components. The upper vent assembly provides ventilation exhaust for cooling of refrigeration components. The venting arrangement further includes a flue exhaust tube assembly. The flue exhaust tube assembly causes the combustion exhaust gases to mix with the ventilation air prior to being exhausted near the upper vent assembly and away from the refrigerator components.

### CROSS-REFERENCE TO RELATED APPLICATIONS

This application claims the benefit of U.S. Provisional Application No. 60/456,703, filed on Mar. 21, 2003. The disclosure of the above application is incorporated herein by reference.

### FIELD OF THE INVENTION

The present invention generally relates to vehicle refrigerators. More particularly, the present invention relates to a venting arrangement for a vehicle refrigerator.

### BACKGROUND OF THE INVENTION

Vehicles, including but not limited to recreational vehicles (“RVs” in the United States and “Caravans” in Europe), tractor trailers, airplanes, boats, trains, and the like, often incorporate refrigerators for the comfort and convenience of the occupants. These refrigerators are usually absorption-type refrigerators.

An absorption refrigerator includes a heat generator for heating a solution of refrigerant and an absorbent. Heat releases the refrigerant from the absorbent to form a high pressure refrigerant vapor. The refrigerant vapor is condensed in a cooling condenser. Low pressure solution from the heat generator is sprayed on the refrigerant vapor in an absorber to absorb the vapor. The absorption causes the pressure of the vapor to be reduced. Evaporation occurs in an evaporator between the condenser and the absorber. The refrigerant vapor expands in the evaporator which causes a temperature drop in the refrigerant. This temperature drop is used to provide cooling to the refrigerator. The solution of refrigerant and absorbent is then pumped back to the heat generator.

Airflow over the condenser and absorber is conventionally used for cooling of these elements. To create this airflow, which is also used to supply air for the combustion at the burner, a first duct or vent is provided through the vehicle wall for air intake. An exhaust is provided through a second duct or vent in the vehicle wall. One such arrangement is shown in commonly assigned U.S. Ser. No. 60/331,083. U.S. Ser. No. 60/331,083 is hereby incorporated by reference as if fully set forth herein.

Vehicle refrigerators such as those described above conventionally vent the combustion exhaust gases by one of two methods. In the first method, an exhaust tube assembly (consisting of one or more components) which is affixed to the refrigerator's cooling unit flue tube is used to couple the combustion exhaust gases directly out through the vehicle sidewall to the outside. In some installations this is accomplished through a hole through the vehicle sidewall; in other installations this is accomplished by attaching the exhaust tube assembly to a specially designed upper vent assembly. In the second method, the refrigerator's cooling unit flue tube vents the combustion exhaust gases unrestricted into the ventilation space and the gases exit the vehicle through the upper vent along with the ventilation air provided for the absorber and condenser.

While both conventional methods for ventilation of the combustion exhaust gases have been proven to be acceptable for their intended uses, both are associated with limitations. In the first method, proper positioning of the exhaust tube assembly relative to the vent openings is time consuming. In one known arrangement, the flue tube is coupled directly to a portion of a vent and the flue tube exhaust is discharged directly out of the vehicle. In this type of arrangement, the original equipment manufacturer (OEM) must cut the final portion of the flue tube to length in order to accommodate variations in both height and distance from the vehicle wall. The OEM must also couple the flue tube to the vent. Extending the flue tube through an independent hole in the wall is even further time consuming. In the second method, the relatively hot combustion exhaust gases mix with the ventilation air. The resultant mixture is warmer and therefore less efficient for cooling the absorber and condenser of the refrigerator's cooling unit.

Accordingly, it remains a need in the pertinent art to provide a venting arrangement for a vehicle refrigerator that overcomes the limitations associated with the prior known arrangements, including but not limited to those disadvantages discussed above.

### SUMMARY OF THE INVENTION

In one form, the present invention provides a venting arrangement for a vehicle refrigerator.

The venting arrangement includes a lower vent assembly and an upper vent assembly. The lower vent assembly provides ventilation intake for cooling of refrigeration components.

The upper vent assembly provides ventilation exhaust for cooling of refrigeration components. The venting arrangement further includes a flue exhaust tube assembly. The flue exhaust tube assembly causes the combustion exhaust gases to mix with the ventilation air prior to being exhausted near the upper vent assembly and away from the refrigerator components.

It is an object of the present invention to provide a venting arrangement for a vehicle refrigerator which promotes mixing of the combustion exhaust gases with ventilation air prior to exiting the vent in a space located away from the refrigerator components through the use of a flue exhaust tube assembly.

It is a related object of the present invention to provide a venting arrangement for a vehicle refrigerator which mixes combustion exhaust gases with ventilation of air prior to exiting a vent in a space located away from the refrigerator components.

It is a related object of the present invention to provide a venting arrangement for a vehicle refrigerator that improves cooling efficiency by increasing the usable surface area of an upper vent assembly and increases the amount of ventilation air which can be delivered.

It is a related object of the present invention to provide a venting arrangement for a vehicle refrigerator which mixes the combustion exhaust gases with ventilation air prior to exiting the vent in a space located away from the refrigerator components to further increase the cooling efficiency of the ventilation air by keeping the hot combustion exhaust gases away from the refrigerator components being cooled by the ventilation air.

It is a related object of the present invention to provide a venting arrangement for a vehicle refrigerator in which a flue exhaust tube assembly is easily adjustable in both height and depth.

It is a related object of the present invention to provide a venting arrangement for a vehicle refrigerator in which the flue exhaust tube assembly's efficiency can be enhanced through the use of a shield or other such attachment which adapts or modifies the flow of the combustion exhaust gases.

It is a related object of the present invention to provide a venting arrangement for a vehicle refrigerator in which the efficiency of an upper vent assembly can be enhanced by providing a hood which protrudes inward to the ventilation space.

It is a related object of the present invention to provide a venting arrangement for a vehicle refrigerator that reduces OEM assembly time.

It is another object of the present invention to provide a venting arrangement for a vehicle refrigerator that reduces the number of the exhaust tube components.

It is another object of the present invention to provide a venting arrangement for a vehicle refrigerator that increases airflow over the back of the refrigerator through reduced resistance and increased chimney effect.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an environmental view of a venting arrangement for a vehicle refrigerator constructed according to the teachings of the present invention, the venting arrangement shown operatively associated with the vehicle refrigerator and installed within a vehicle.

FIG. 2 is an exploded view of a portion of the venting arrangement of the present invention illustrating the connection between the cooling unit flue tube and a flue exhaust tube of the venting arrangement of the present invention.

FIG. 3 is a top view of a portion of the flue exhaust tube illustrating attachment of the flue exhaust tube shield.

FIG. 4 is a side view of a portion of the flue exhaust tube further illustrating attachment of the flue exhaust tube shield.

### DETAILED DESCRIPTION OF THE PREFERRED EMBODIMENTS

The following description of the preferred embodiments of the present invention is merely exemplary in nature and is in no way intended to limit the invention, its application, or uses.

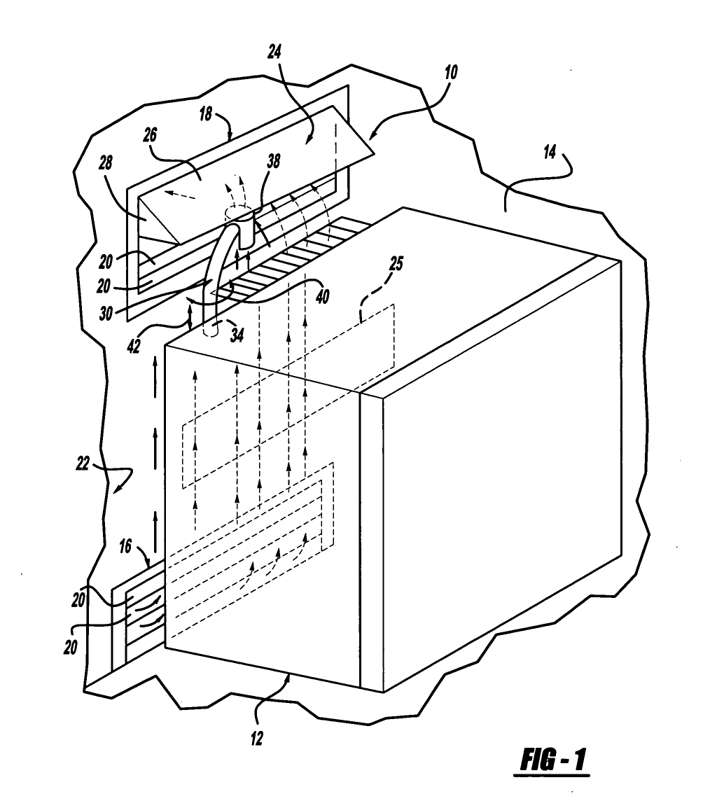

Referring initially to FIG. 1, a venting arrangement for a vehicle refrigerator constructed in accordance with the teachings of the present invention is illustrated and generally identified at reference number 10. The venting arrangement 10 is shown operatively associated with a vehicle refrigerator 12 that is conventionally installed within a vehicle 14. In the exemplary arrangement illustrated, the vehicle is a recreational vehicle 14. It will become apparent to those skilled in the art, however, that the teachings of the present invention are not so limited. In this regard, the teachings of the present invention have application for any vehicle incorporating a refrigerator requiring the discharge of flue gases.

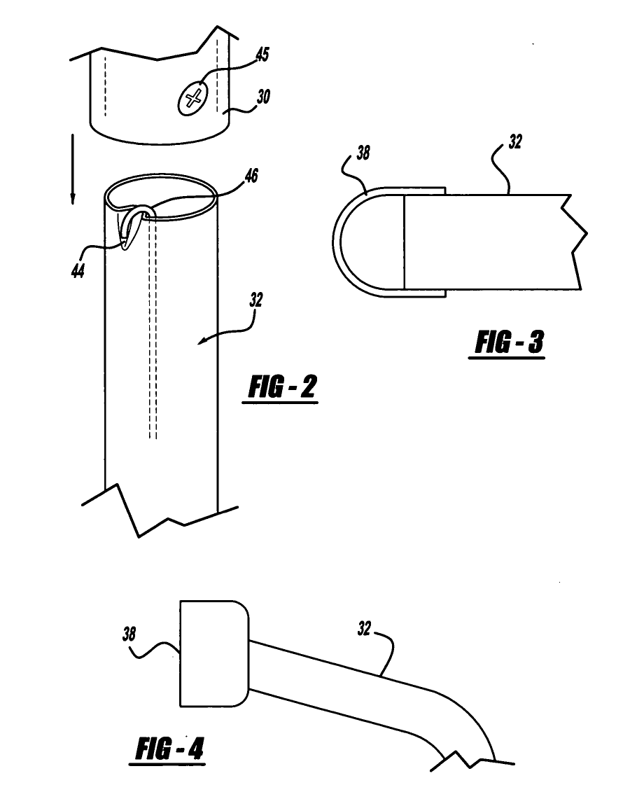

With continued reference to FIG. 1 and additional reference to FIGS. 3 and 4, the teachings of the present invention will be further addressed. The venting arrangement 10 is illustrated to generally include a first or lower vent assembly 16 and a second or upper vent assembly 18. The lower vent assembly 16 includes a plurality of louvers 20 and defines an air intake for the venting arrangement 10. The lower vent assembly 16 is mounted to a wall 22 of the vehicle 14 in any manner well known in the art. One particular manner for mounting is shown and described in commonly assigned U.S. Ser. No. 60/331,083, which was incorporated by reference above.

The upper vent assembly 18 will be understood to be substantially identical to the lower vent assembly 16 with the exception that the upper vent assembly 18 further includes an inwardly directed hood or cover 24. In this regard, the upper vent assembly 18 includes a plurality of louvers 20. The upper vent assembly 18 defines an air exhaust for the venting arrangement 10 of the present invention and again is secured to the wall 22 of the vehicle 14 in any conventional manner.

In the exemplary embodiment illustrated, the upper vent assembly 18 and the lower vent assembly 16 are injection molded of a plastic material. Those skilled in the art will appreciate that other materials and manners of construction may be employed within the scope of the present invention. The upper vent assembly 18 is integrally formed to include the hood 24. As shown, the hood 24 includes an upper panel 26 which extends inward from an upper portion of the vent assembly 18. The hood 24 may include one or more triangular sides, one of which is identified at reference character 28.

The lower and upper vent assemblies 16 and 18 cooperate to define an airflow path therebetween. The airflow path provides a source of cooling air which passes across the refrigeration components (e.g., the condenser and absorber sections) of the refrigerator 12. The refrigeration components are shown schematically at reference character 25 in FIG. 1. This airflow may also provide the cooling unit flue a source of combustion air for the burner of the refrigerator 12.

The venting arrangement 10 of the present invention is further illustrated to include a flue exhaust tube 30 which adjustably mounts to a cooling unit flue tube 32 (see FIG. 2). The flue exhaust tube 30 may be constructed of metal or other suitable materials and generally includes a vertically oriented lower portion 34 and an angled upper portion 36. The lower portion 34 is coupled to the cooling unit flue tube 32 in a manner to be described below.

The upper portion 36 terminates at a shield 38. The shield 38 may be constructed of metal such as aluminum or other suitable materials and is welded or otherwise permanently attached to the open end of the flue exhaust tube 30. The shield 38 enhances the efficiency and effectiveness of the flue exhaust tube 30 in mixing with the cooling ventilation air by creating a small chimney effect of air with the hot combustion gases naturally rising to the top portion of the shield 38. In the embodiment illustrated, the shield 38 includes first and second sides attached to radially opposite sides of the flue exhaust tube 32.

The shield 38 deflects a horizontal component of the exhaust gases. In this manner, cooler ventilation air is drawn from the bottom as it mixes before being exhausted through the upper vent assembly 18. As will be appreciated below, the flue exhaust tube 30 is rotatably adjustable in the directions of double arrow 40 (see FIG. 1) and vertically adjustable in the directions of double arrow 42 (see FIG. 1).

In the preferred embodiment, an upper end of the cooling unit flue tube 32 is formed to include an indent 44. The indent 44 accommodates a wire 46 for the baffle while also allowing telescopic connection with a cylindrical flue exhaust tube 30. In this manner, the flue exhaust tube 30 can be rotated relative to the cooling unit flue tube 32 about an axis defined by a longitudinal axis of the cooling unit flue tube 32.

During final assembly by the OEM, the flue exhaust tube 30 is rotated relative to the cooling unit flue tube 32 such that the end of the flue exhaust tube 30 and the shield 38 are disposed below the inwardly extending hood 24. As used herein, the terms “below” and “under” will be understood to include a relationship on which the shield 38 at least partially extends into an area defined by the upper panel 26 and sides 28 of the hood 24. Importantly, the shield 38 is positioned such that the hood 24 captures the warmer air that is emitted from the flue exhaust tube 30.

With the end of the flue exhaust tube 30 and the shield 38 positioned below the hood 24, the flue exhaust tube 30 is vertically adjusted to achieve an optimum position under the hood 24. In one particular application, the flue exhaust tube 30 can be vertically adjusted approximately 100 mm. The relative positions between the flue exhaust tube 30 and cooling unit flue tube 32 can be maintained with a set screw (45).

During operation, a source of cooling air enters the lower vent assembly 16 and passes across the condenser and absorber sections of the refrigerator 12 to cool the components of the refrigerator 12. The cooling air exits the vehicle 14 at the upper vent assembly 18. The heated combustion exhaust gases exit the flue exhaust tube 30 proximate the shield 38. These combustion exhaust gases immediately mix with the cooling air moving between the lower vent assembly 16 and the upper vent assembly 18. In this manner, the flue exhaust gases are carried out of the vehicle 14 with the airflow.

The description of the invention is merely exemplary in nature and, thus, variations that do not depart from the gist of the invention are intended to be within the scope of the invention. Such variations are not to be regarded as a departure from the spirit and scope of the invention.

1. A venting arrangement for a vehicle refrigerator, comprising:
a) a lower vent assembly which provides ventilation intake for cooling of refrigeration components;
b) an upper vent assembly which provides ventilation exhaust for cooling of refrigeration components; and
c) a flue exhaust tube assembly which cause the combustion exhaust gases to mix with the ventilation air prior to being exhausted near the upper vent assembly and away from the refrigerator components.

2. The venting arrangement for a vehicle refrigerator of claim 1, wherein the upper vent assembly includes a hood to enhance the efficiency and effectiveness of the upper vent assembly when used in combination with the flue exhaust tube assembly.

3. The venting arrangement for a vehicle refrigerator of claim 1, further comprising a flue exhaust tube shield operative to create a small chimney effect of air with the hot combustion gases naturally rising to a top portion of the shield thus drawing cooler ventilation air from the bottom as it mixes before being exhausted through the upper vent assembly.

4. The venting arrangement for a vehicle refrigerator of claim 3, wherein the flue exhaust tube shield is secured to an end of the flue exhaust tube.

5. The venting arrangement for a vehicle refrigerator of claim 4, wherein the flue exhaust tube includes an outlet and the hood is positioned above the outlet.

6. The venting arrangement for a vehicle refrigerator of claim 1, wherein the flue exhaust tube includes an outlet through which the exhaust gases are emitted and further comprising a flue exhaust tube shield secured to the flue exhaust tube proximate the outlet for deflecting a horizontal component of the exhaust gases.

7. The venting arrangement for a vehicle refrigerator of claim 5, wherein the flue exhaust tube shield includes first and second sides secured to radially opposing sides of the flue exhaust tube.

8. The venting arrangement for a vehicle refrigerator of claim 1, in combination with the refrigerator.

9. A venting arrangement for a vehicle refrigerator, the venting arrangement comprising:
a cooling unit flue tube; and
a flue exhaust tube connected to the cooling unit flue tube, the flue exhaust tube being linearly adjustable relative to the cooling unit flue tube in a vertical direction and rotatably adjustable relative to the cooling unit flue tube about an axis defined by the cooling unit flue tube, the flue exhaust tube having an outlet for emitting a source of exhaust gases.

10. The venting arrangement for a vehicle refrigerator of claim 9, wherein the cooling unit flue tube and the flue exhaust tube are telescopically related.

11. The venting arrangement for a vehicle refrigerator of claim 9, further comprising a first vent assembly for attachment to an outside wall of the vehicle, the first vent assembly defining a vent opening for an airflow, the outlet being spaced from but proximate to the vent opening.

12. The venting arrangement for a vehicle refrigerator of claim 11, wherein the first vent assembly includes an inwardly extending hood.

13. The venting arrangement for a vehicle refrigerator of claim 12, wherein the hood is integrally formed with the first vent assembly.

14. The venting arrangement for a vehicle refrigerator of claim 9, wherein the flue exhaust tube includes a shield secured to the end.

15. The venting arrangement for a vehicle refrigerator of claim 9, wherein the flue exhaust tube includes a vertically extending lower end and an angled upper end.

16. A method of venting a vehicle refrigerator, the method comprising:
(a) providing a lower vent assembly defining a ventilation intake;
(b) providing an upper vent assembly defining a ventilation exhaust;
(c) establishing flow of ventilation air between the ventilation intake and the ventilation exhaust for cooling one or more components of the refrigerator; and
(d) mixing a combustion exhaust gas of the vehicle refrigerator with the flow of ventilation air prior to expulsion of the flow of ventilation air through the upper vent assembly.

17. The method of claim 16, further comprising:
routing the combustion exhaust gas through a conduit including a lower member and an upper member, the upper member including an outlet in close proximity to the ventilation exhaust.

18. The method of claim 16, further comprising adjusting the outlet relative tot eh ventilation exhaust by telescoping the upper and lower members.

19. The method of claim 16, further comprising adjusting the outlet relative to the ventilation exhaust by rotating the upper member relative to the lower member.

20. The method of claim 17, further comprising deflecting the ventilation exhaust with a shield secured to the upper member.
